(19) United States
(12) Patent Application Publication
(10) Pub. No.: US 2009/0178068 A1
(43) Pub. Date: Jul. 9, 2009

(54) MULTIMEDIA PLAYER

(75) Inventors: Shih-Yun Lee, Tao Yuan Shien (TW); Yun-Liang Hsieh, Tao Yuan Shien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QUANTA COMPUTER INC., Tao Yuan Shien (TW)

(21) Appl. No.: 12/107,223

(22) Filed: Apr. 22, 2008

(30) Foreign Application Priority Data
Jan. 8, 2008 (TW) 97200427

(51) Int. Cl. G11B 33/02

(52) U.S. Cl. 720/657

(57) ABSTRACT

A multimedia player is disclosed, including a base, a cover rotatably disposed on the base, an engaging mechanism disposed on the base, an elastic element connecting the base and the cover, and a carrier disposed on the cover to carry a media source. When the cover is closed to cover the base, the cover engages the base with the engaging mechanism, and the elastic element is biased to store an elastic potential and when the cover is released from the engaging mechanism, the elastic potential is released to open the cover.

### BACKGROUND OF THE INVENTION

1. Field of the Invention

The invention relates to a multimedia player.

2. Description of the Related Art

Personal computers installed with Windows XP MCE by Microsoft Co. can be a multimedia center, which is often only used indoors. Portable multimedia devices such as iPod by Apple Co. are also popular. A connecting device for connecting a portable multimedia player to a personal computer is desired.

### BRIEF SUMMARY OF INVENTION

An embodiment of a multimedia player of the invention comprises a base, a cover rotatably disposed on the base, an engaging mechanism disposed on the base, an elastic element connecting the base and the cover, and a carrier disposed on the cover to carry a media source. When the cover is closed to cover the base, the cover engages the base with the engaging mechanism, and the elastic element is biased to store an elastic potential and when the cover is released from the engaging mechanism, the elastic potential is released to open the cover.

The multimedia player further comprises a hinge connecting the cover and the base, whereby the cover is rotatably connected to the base.

The hinge comprises a first joining portion, a second joining portion and a connecting portion, and the first joining portion is joined to the base, the second joining portion is joined to the cover and the connecting portion connects the first joining portion and the second joining portion. When the cover is opened by the elastic potential, the connecting portion deforms to retard the cover.

The elastic element can be a torsion spring with one end contacting the cover and the other end joined to the base.

The engaging mechanism can be a push-push hook.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a perspective view of a multimedia player of the invention with a closed cover;

FIG. 2 is a perspective view of a multimedia player of the invention with an opened cover;

FIG. 3 is an exploded view of a multimedia player of the invention; and

FIG. 4 is a schematic view of a hinge of the multimedia player of the invention.

### DETAILED DESCRIPTION OF INVENTION

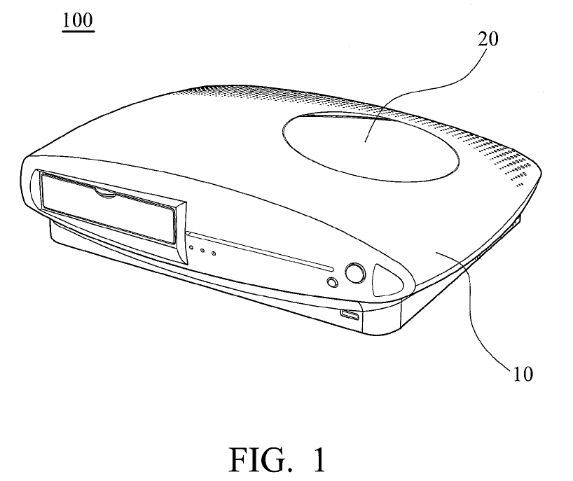

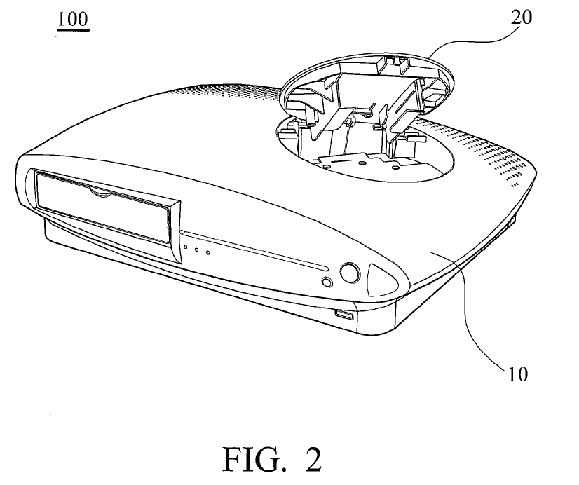

Referring to FIGS. 1 and 2, a multimedia player 100 comprises a base 10 and a cover 20 with a closed cover and an opened cover respectively.

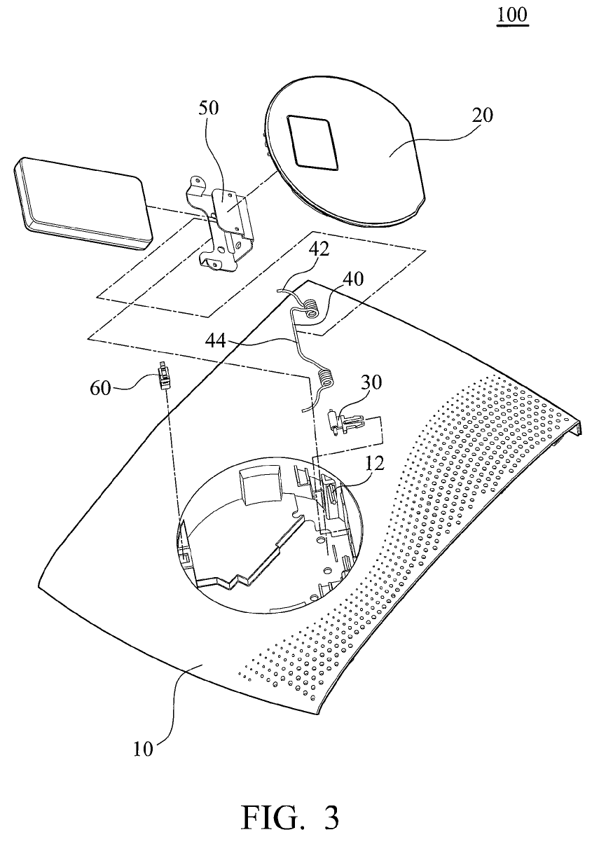

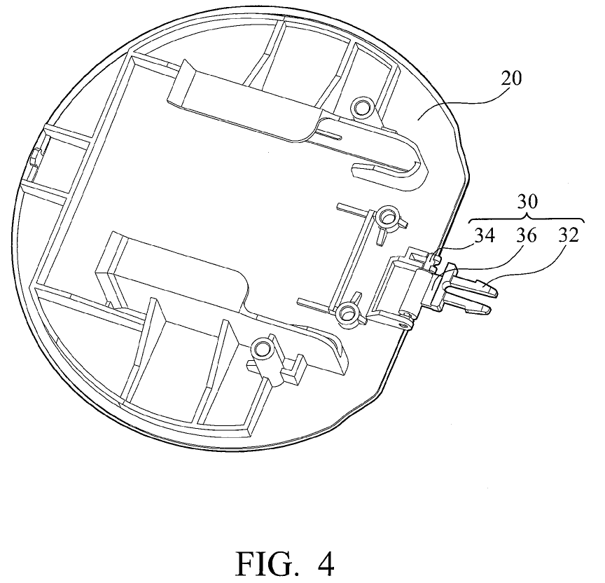

Referring to FIG. 3, the multimedia player 100 further comprises a hinge 30, an elastic element 40, a carrier 50 and an engaging mechanism 60. Referring to FIG. 4, the hinge 30 connects the base 10 and the cover 20, whereby the cover 20 is rotatably joined to the base 10. The hinge 30 comprises a first joining portion 32, a second joining portion 34 and a connecting portion 36. The first joining portion 32 is planar and inserted into a slot (not shown) in the base 10. The second joining portion 34 is circular and engaged with a depression on the cover 20. The connecting portion 36 connects the first joining portion 32 and the second joining portion 34.

The elastic element 40, which is a torsion spring in this embodiment, is disposed on a shaft 12 of the base 10 with one end 42 abutting the base 10 and U-shaped portion 44 abutting the cover 20. The carrier 50 is fixed to an inner surface of the cover 20. An iPod or other media sources can be inserted into the carrier 50, then the cover 20 is pushed down to be closed. At this time, the cover 20 is fixed to the base 10 by the engaging mechanism 60. In this embodiment, the engaging mechanism 60 is a push-push hook.

While pushing the cover 20 towards the base 10, the engaging mechanism 60 engages the cover 20 with the base 10 and the elastic element 40 is biased to store an elastic potential at the same time. While, the cover 20 is pushed again, the engagement of the engaging mechanism 60 between the cover 20 and the base 10 is released and the cover 20 is opened by the recovery force (elastic potential) of the elastic element 40. At this time, the connecting portion 36 of the hinge 30 deforms to retard the rising of the cover 20.

When the cover 20 is opened, an iPod or other media sources can be removed from the carrier 50.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimedia player, comprising:
a base;
a cover rotatably disposed on the base;
an engaging mechanism disposed on the base;
an elastic element connecting the base and the cover; and
a carrier disposed on the cover to carry a media source, wherein when the cover is closed to cover the base, the cover engages the base with the engaging mechanism, and the elastic element is biased to store an elastic potential and when the cover is released from the engaging mechanism, the elastic potential is released to open the cover.

2. The multimedia player as claimed in claim 1 further comprising a hinge connecting the cover and the base, whereby the cover is rotatably connected to the base.

3. The multimedia player as claimed in claim 2, wherein the hinge comprises a first joining portion, a second joining portion and a connecting portion, and the first joining portion is joined to the base, the second joining portion is joined to the cover and the connecting portion connects the first joining portion and the second joining portion.

4. The multimedia player as claimed in claim 3, wherein when the cover is opened by the elastic potential, the connecting portion deforms to retard the rising of the cover.

5. The multimedia player as claimed in claim 1, wherein the elastic element is a torsion spring with one end contacting the cover and the other end joined to the base.

6. The multimedia player as claimed in claim 1, wherein the engaging mechanism is a push-push hook.

7. The multimedia player as claimed in claim 4, wherein the elastic element is a torsion spring with one end contacting the cover and the other end joined to the base.

8. The multimedia player as claimed in claim 7, wherein the engaging mechanism is a push-push hook.
